(19) United States
(12) Patent Application Publication
(10) Pub. No.: US 2014/0129275 A1
(43) Pub. Date: May 8, 2014

(54) METHOD AND APPARATUS FOR PUSHING OF TASKS FROM AN APPLICATION OR WEBSITE TO ANOTHER APPLICATION

(71) Applicant: BANK OF AMERICA CORPORATION, Charlotte, NC (US)

(72) Inventors: Alicia C. Jones, Fort Mill, SC (US); Matthew Perkins, Charlotte, NC (US); James E. Burgess, Charlotte, NC (US)

(73) Assignee: BANK OF AMERICA CORPORATION, Charlotte, NC (US)

(21) Appl. No.: 13/672,328

(22) Filed: Nov. 8, 2012

(51) Int. Cl. G06Q 10/00; G06Q 30/02

(52) U.S. Cl. 705/7.15

(57) ABSTRACT

A computer implemented method comprises transmitting by a first device having a first processor a task request initiated by a first user from the first device to a second device. The task is configured to be received by the second device so that a second user can perform the task. The method further comprises receiving by the first device a notice that the second user has performed a task, transmitting by the first device a request for a transaction to reward the second user for performing the task, and transmitting by the first device a notice of a reward to the second device. The task relates to finances, and the task can involve counting currency. The transaction comprises a monetary amount delivered to an account held by the second user or purchasing a credit to a vendor.

### TECHNICAL FIELD

Aspects of the disclosure relate to website or device applications that push tasks from one device to another device.

### BACKGROUND

Currently, there are applications such as portable device applications that serve as money-counting applications. These applications are useful and can be used in conjunction with the disclosure herein. The system, in one example, is designed to push requests to another person's device applications or personal website. The system disclosed herein is directed to allowing one user (e.g., a parent) of a website or an application (e.g., a banking website or application) to push a task or challenge to another user's (e.g., a child) device or personal website.

In one example, a parent who is paying bills could push a task to his/her child to perform an arithmetic task associated with paying a bill. The level of the task can vary depending on the child's age. For example, the child could be tasked with virtually counting out the amount of a recent utility bill. The child could have his/her own smart phone or other device that has various applications (e.g., a money-counting application) that could be activated by the parent's smart phone or other device. The child could earn various rewards (e.g., allowance, bonus points, or other type of incentive) for completing the task.

### BRIEF SUMMARY

The following presents a simplified summary of the disclosure in order to provide a basic understanding of some aspects of the invention. It is not intended to identify key or critical elements of the invention or to delineate the scope of the invention. The following summary merely presents some concepts of the disclosure in a simplified form as a prelude to the more detailed description provided below.

In an exemplary embodiment, a computer implemented method comprises transmitting by a first device having a first processor a task request initiated by a first user from the first device to a second device, and the task is configured to be received by the second device so that a second user can perform the task on the second device. The method further comprises receiving by the first device a notice that the second user has performed the task, transmitting by the first device a request for a transaction to reward the second user for performing the task, and transmitting by the first device a notice of a reward to the second device.

The task relates to finances, and the task can involve counting currency. The transaction comprises a monetary amount delivered to an account held by the second user or purchasing a credit to a vendor. The account held by the second user is linked to the second device such that the monetary amount is transferred into the account held by the second user. The method further comprises configuring the first device to automatically reward the second user after a predetermined one or more tasks are performed by the second user on the second device. Additionally, a second task can be transmitted by the first device to a third device, and the first device can receive a notice that a third user has performed the second task on the third device. The first device can include an option for the first user on the first device to customize a reward for the second user.

In another exemplary embodiment, a method comprises receiving a task request from a first device initiated by a first user on a second device having a processor, displaying the task on the second device and providing a second user an option to perform the task on the second device, sending a message from the second device to the first device that the task has been performed by the second user and alerting the first user that the task has been performed, and receiving and displaying a notice of a reward on the second device in response to the second user performing the task on the second device.

The task relates to finances. In particular, the task comprises counting currency, and the second device provides a graphical user interface for the second user to virtually count currency. The reward is a monetary amount or a credit to a vendor. The account held by the second user is linked to the second device such that the monetary amount is transferred into the account held by the second user from an account held by the first user. The second user is automatically rewarded after a predetermined one or more tasks are performed by the second user on the second device. The second device is configured to lock up when the second user does not perform the task after a predetermined amount of time.

Aspects of the invention may be provided in a computer-readable medium having computer-executable instructions to perform one or more of the process steps described herein.

These and other aspects of the invention are discussed in greater detail throughout this disclosure, including the accompanying drawings.

### BRIEF DESCRIPTION OF THE DRAWINGS

The present disclosure is illustrated by way of example and not limited in the accompanying FIGS. in which like reference numerals indicate similar elements and in which:

FIG. 1 shows an illustrative operating environment in which various aspects of the invention may be implemented.

FIGS. 2-6 illustrate an exemplary graphic user interfaces according to exemplary embodiments of the invention.

### DETAILED DESCRIPTION

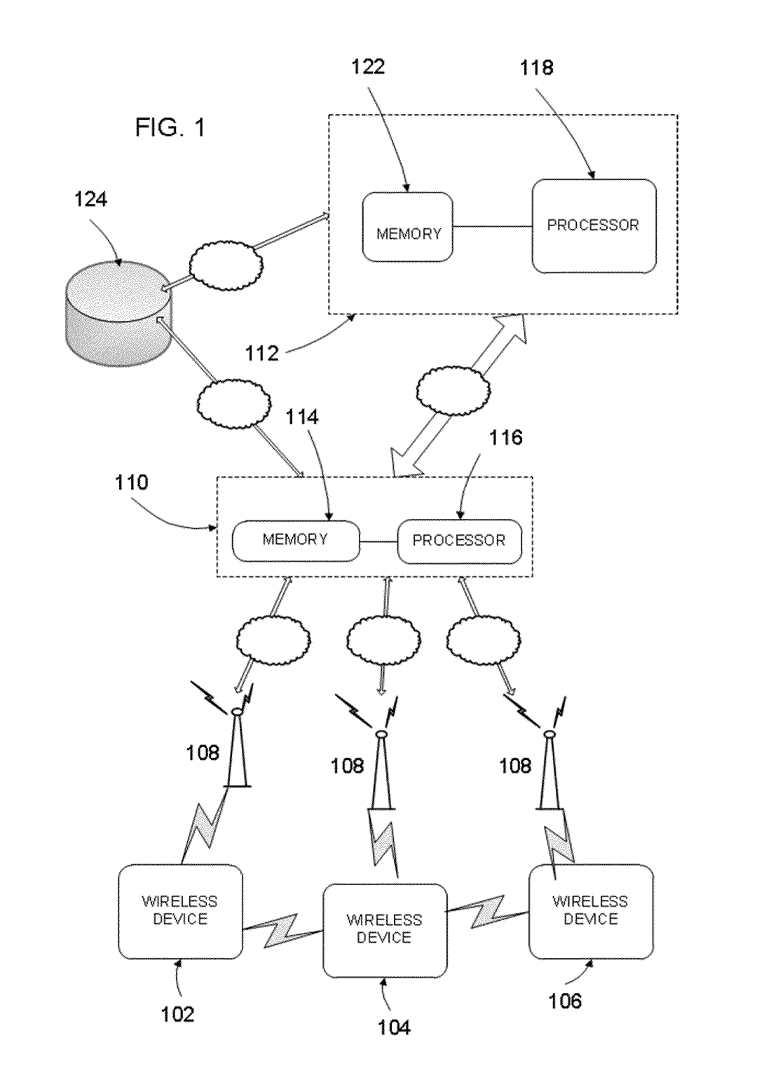

FIG. 1 depicts an illustrative operating environment in accordance with aspects of the disclosure. Computing devices 102, 104, 106 configured for wireless transmission can connect to each other, the various components described herein, and other computing devices through the wireless access points 108. It is also contemplated that this can be accomplished by direct connections. The above connections can be made via the Internet, blue tooth, Wi-Fi, infrared, or any other known method of wireless transmission. The computing devices 102, 104, 106 may be mobile telephones or smartphones with applications and other functionality, a handheld device with Wi-Fi or other wireless connectivity (e.g., tablets, tablet computers, PDAs, and the like), or any other known computer, computing device, or handheld computer.

In addition, the computing devices 102, 104, 108 can be enabled to communicate with the wireless access points 108 which can be a series of cellular towers hosted by a service provider. Additionally, the wireless access points 108 may be Wi-Fi (e.g., compatible with IEEE 802.11a/b/g/ and the like wireless communication standards) connections and the computing devices 102, 104, 106 may obtain access to the Internet at these connections. Other known techniques may be used to allow the computing devices 102, 104, 106 to connect with a network.

A server 110 can receive data communicated from the user devices 102, 104, 106. Sever 110, for example, a high-grade sever computer, may include a processor 116 for executing computer-readable instructions and a memory 114 for storing the computer-readable instructions. The user devices 102, 104, 106 may transmit data to the server 108 over the network through the wireless access points 108. A second server 112 may be comprised of a processor 118 for executing the computer-readable instructions and a memory 122 for storing computer-readable instructions in accordance with aspects of the disclosure. Computer data that may be useful to various applications running on the devices 102, 104, 106 or the servers 110, 112 may be stored on the memories 114, 122. For example, the computer data may include security information, bank account information, user login/profile information, service provider list and related information, and/or other information. This data may also be used to support one or more of the numerous features disclosed throughout this disclosure.

The servers are not limited to a single machine or device. For example, the server may be implemented as a web server, Internet-accessible server, or cloud-based server. Furthermore, the term server refers to any system of computers and/or arrangement of devices (e.g., firewalls, routers, caching systems, proxy servers, and the like or combination thereof) that may be used to provide a connection to services and features available for use. As such, different reference to the server performing particular steps does not require that the same machine/device perform all the steps.

The wireless access points 108, servers 110, 112, and the data store 124 can be configured to communicate over a wireless connection or a wired connection. In certain examples, a secure and private link can be created between one or more of these mechanisms. For example, a network cloud representing the Internet can be used to link the servers 110, 112 and the data store 124. Alternatively, a secure WAN or a dedicated T1 (or other telecommunications) line may connect the servers 110, 112 and data store 124.

It is also contemplated that the devices 102, 104, 106 may include memories, processors, display screens (e.g., touchscreens), keypads, cameras, sensors (e.g., motion, light, and the like), global positioning system (GPS) components, audio output/input devices, and other electronic components configured for use in mobile phones, tablets, PDAs, mini-laptops, or other computing devices.

Additionally, the servers 110, 112 may include processors, memories (RAM, ROM), communications modules, and/or memories for storing operating systems, applications, and/or data. The servers may have processors for controlling overall operation of the servers and their associated components, including random access memories, read-only memories, communications modules, and other types of memories. Such servers may include a variety of computer readable media. The computer readable media can be any available media, including tangible and intangible, that can be accessed by the servers and includes both volatile and nonvolatile media, and removable and non-removable media. By way of example, and not limitation, computer readable media may include a combination of computer storage media and communication media.

Computer storage media includes volatile and nonvolatile, removable and non-removable media implemented in any method or technology for storage of information such as computer readable instructions, object code, data structures, program modules or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the server.

The aforementioned server may include one or more applications representing the application data stored in RAM memory while the server is on and corresponding software applications (e.g., software tasks) are running on the server. The aforementioned communications module may include a microphone, keypad, touch screen, and/or stylus through which an (optional) user of the server may provide input, and may also include one or more of a speaker for providing audio output and a video display device for providing textual, audio/visual and/or graphical output. Software may be stored within the memory and/or storage to provide instructions to the processor for enabling the server to perform various functions. For example, memory may store software used by the server, such as an operating system, application programs, and/or an associated database. Alternatively, some or all of the computer executable instructions for the server may be embodied in hardware or firmware. Moreover, a database (or data store) 124 may provide centralized storage of data.

Such a server may operate in a networked environment supporting connections to one or more remote computing devices. The remote computing devices may be personal computing devices or servers that include many or all of the elements described above relative to the server. Remote computing devices may be a mobile device communicating over wireless carrier channel. The network connections depicted in FIG. 1 may include a local area network (LAN) and/or a wide area network (WAN), but may also include other networks. When used in a LAN networking environment, the server may be connected to the LAN through a network interface or adapter in the communications module. When used in a WAN networking environment, the server may include a modem in the communications module or other means for establishing communications over the WAN, such as the Internet. It will be appreciated that the network connections shown and described are illustrative and other means of establishing a communications link between the devices may be used. The existence of any of various well-known protocols such as TCP/IP, Ethernet, FTP, HTTP and the like is presumed, and the system can be operated in a client-server configuration to permit a user to retrieve web pages from a web-based server. Any of the various commonly known web browsers can be used to display and manipulate data on web pages.

As understood by those skilled in the art, the system and steps that disclosed herein and in the Figures may be implemented by one or more of the components in FIG. 1 and/or other components, including other computing devices. The systems and applications disclosed herein can be implemented in various forms for example, a website, smart phone application, tablet application, or other portable device application.

In one exemplary embodiment, the application can be configured to permit one user to push certain requests from a first device to a second person's device or personal website. In one example, these requests can be requests aimed at teaching children about finances. However, other uses are also contemplated, such as an employer pushing tasks to an employee, team leader pushing tasks to team members, teacher pushing tasks to a group of students, and the like. The system can permit one user of a website or application, such as a parent to push a task or challenge to another user (e.g., a child) of a computing device or personal website. In this way, the parent can request that the child perform a task, which can help the child better understand the value of money.

In another embodiment, a parent who is paying bills could push a task to his/her child to perform an arithmetic task associated with paying various bills. The child's computing device can receive this task, and the child could perform this task on his/her computing device in an application on the child's computing device. Once the task is performed, the child's computing device could then send a message back to the parent's computing device indicating that the task has been completed, and the child can then be rewarded accordingly.

In an exemplary embodiment, the parent may select the level of the task depending on the child's age and ability, and the application can also suggest tasks that may be appropriate for the child based on his or her age. The parent can also set a rule for automatically pushing tasks to the child. In one example, the task could be virtually counting out the amount of the recent utility bill. The parent can set the application to automatically push the task of counting out the amount of the utility bill each month by creating one or more rules. The child could have his/her own smart phone or other computing device that has various applications that could be activated by the parent's smart phone (e.g., a money-counting application) for performing the task.

The child's device can alert the child that the task has been pushed to his/her phone, and the child can select the application to complete the task or the task can be pushed directly to a particular application on the child's device. The child can then attempt to complete the task. The application can be configured to check the child's accuracy in performing the task and can be configured to allow the child to attempt the problem a predetermined number of times. If the child does not perform the task within the predetermined number of times, the program can deny credit for the task, and the child must complete a new task to obtain credits towards rewards. The child's device can also send reminders to the child to complete the tasks and communicate back to the parent's device to report progress on performing tasks. In addition, the parent's application can be configured to automatically send reminders to the parent to follow up with the child regarding a particular task. The parent can also set a deadline for the child to perform the task, and after the deadline the task can no longer be performed for credit toward a reward. The child can receive reminders according to the deadline either from the child's application or from the parent's application.

As discussed herein, the child can also be incentivized to complete the tasks pushed to his/her computing device. For example, the child could earn various rewards (e.g., allowance, bonus points, or an achievement). Additionally, the child's application could have a piggy bank feature that can be cashed into a child's corresponding bank account or the application can partner with an online vendor, and the child can be rewarded with a virtual gift card on his or her personal device. The child can also make a wish list and one or more of the items can be earned by successfully completing a predetermined number of tasks.

The number and difficulty of the tasks for receiving an award can be customized by the parent or the parent's application can suggest default settings for reward giving to the child based on difficulty and the number of tasks. In another embodiment, the parent could set up a lockout period on the child's device if the child does not complete the requested task in a predetermined period of time. For example, if the child does not complete the task for a certain time period, the child's device could lock the child out from certain programs on the child's device, until the child performs the required task or tasks.

If the reward is monetary, the parent's application can be configured to withdraw the amount of the reward from the parent's account and transfer that amount to the child's account. If the child does not have an account set up to receive the transfer, the application can make suggestions regarding accounts and can provide the user with options for setting up an account. In this way, the financial institution supporting the application can advertise its services to users and try to earn the user's business by permitting the user to open account with the financial institution on either the parent's or the child's device.

If the reward is a virtual gift card, the parents computing device can be configured to provide the parent with various vendor options that the parent can select from. The computing device can be configured to deduct the amount from the gift card from the parent's bank account. Alternatively, the child can earn credits toward a virtual gift card and the child can be permitted to select the gift card and the vendor.

In another exemplary embodiment, the first user could push a certain task to a group of users and the first user's application could track which users completed the task. In this way, a parent, for example, could send the task to more than one child, and each child can complete the task independently. In another example a teacher could push a task to more than one student at a time and each student could attempt the task. The teacher's computing device could track the progress of the students in completing the tasks. The teacher could reward the students through the application in accordance with the embodiments discussed herein.

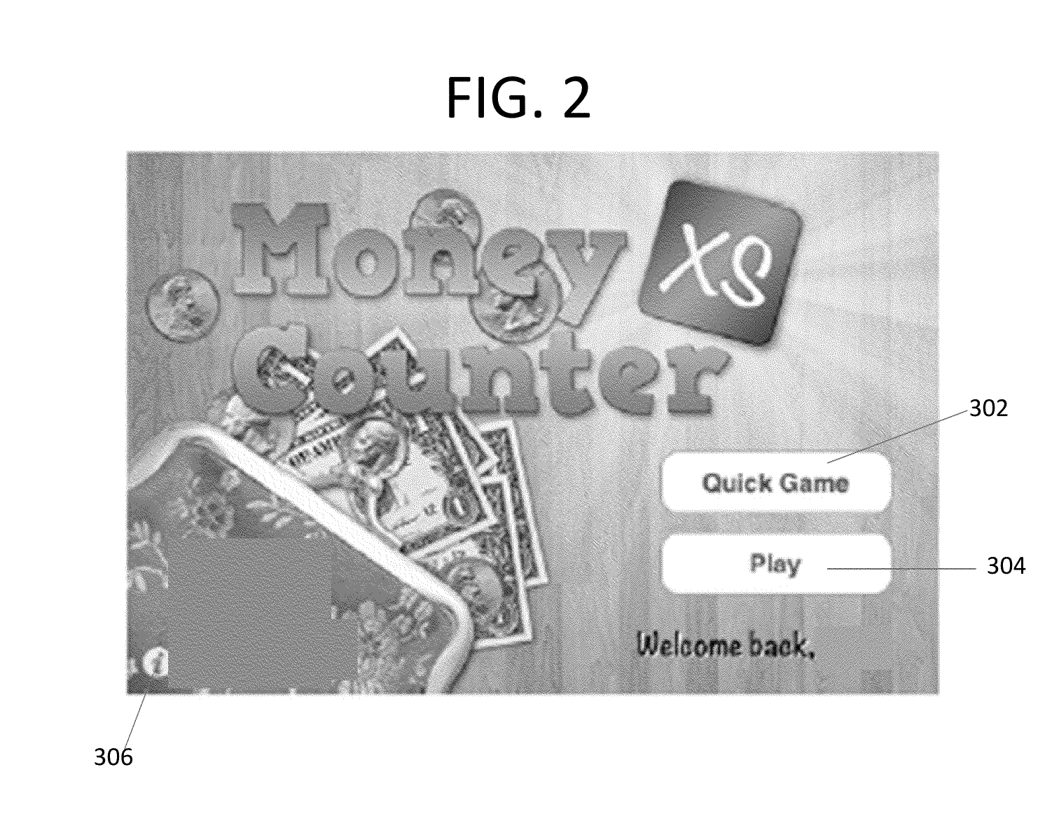

FIGS. 2-5 depict various screen shots that can be used for one or more exemplary applications configured for a smart phone, tablet, or other computing device. In the application(s) depicted in the screen shots of FIGS. 2-5, the users can play various money counting games or perform various parent challenges that are pushed to the user's computing device.

FIG. 2 depicts an initial application title screen that is displayed once a money counting application is launched. The user can select “Quick Game” 302 to play a quick “Money Counting” game or “Play” 304 to select a game and play. The user can also select settings 306 to adjust the current settings of the application. The application title screen can also be configured to display the current player information.

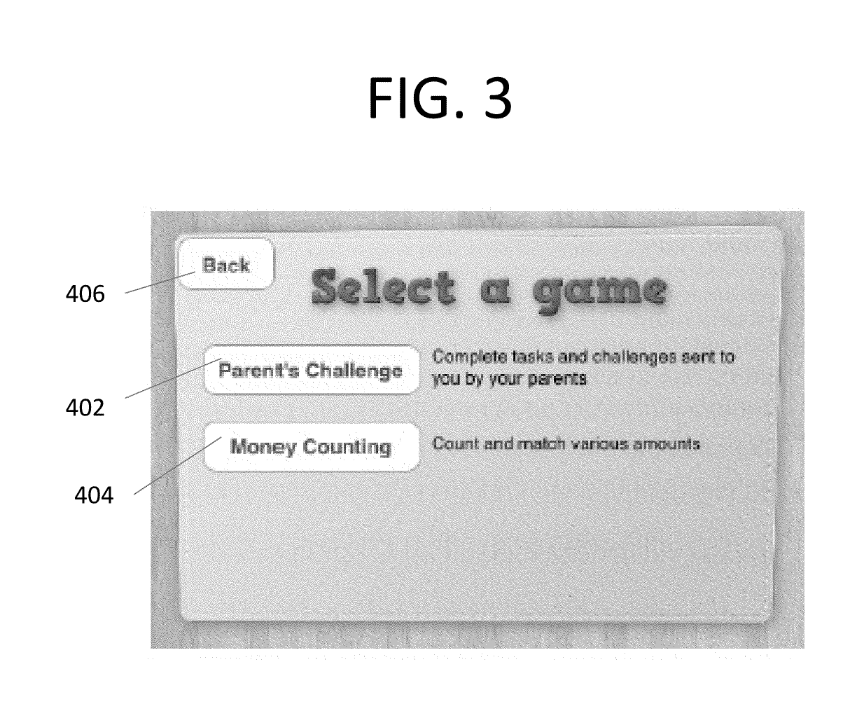

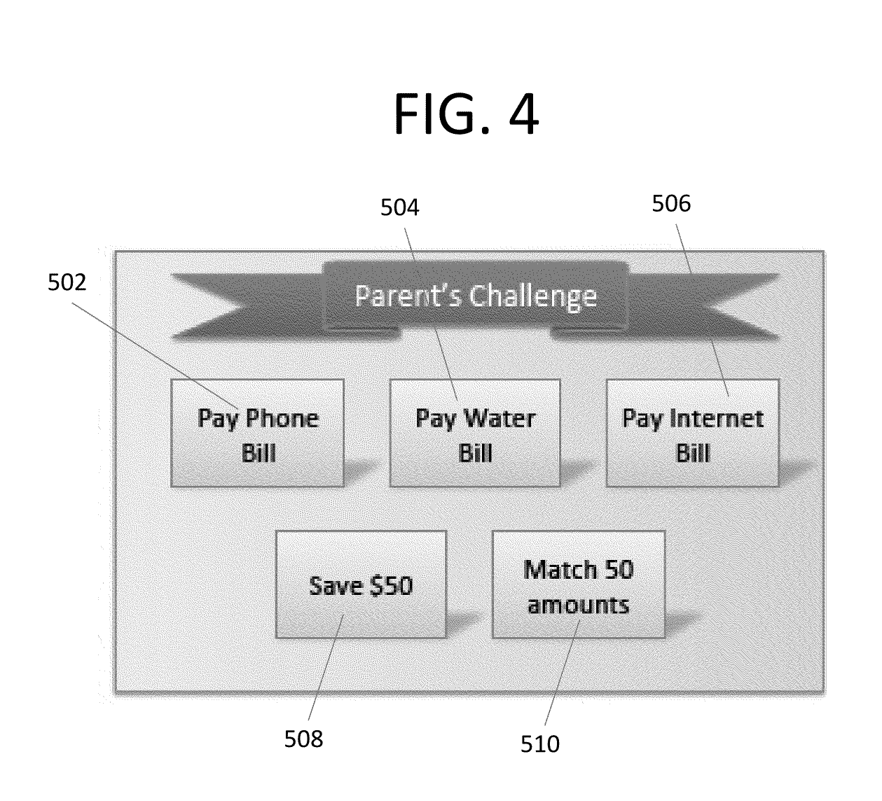

FIG. 3 shows another screen shot depicting the next screen after the user selects “Play” in the screen shot shown in FIG. 2. The user can then select between a “Parents Challenge” option 402, a “Money Counting” option 404 or “Back” 406 to the prior screen. Another menu of the “Parents Challenge” game appears in FIG. 4. In the exemplary embodiment shown in FIG. 4, the “Parents Challenge” can be one of the menu selection items depicted in FIG. 4, “Pay Phone Bill” 502, “Pay Water Bill” 504, “Pay Internet Bill” 506, “Save $50” 508, or “Match 50 amounts” 510.

Selecting the menu option “Pay Phone Bill” 502, “Pay Water Bill” 504, “Pay Internet Bill” 506 could push the task of counting out the currency needed to make up the amount of the bill to the child. The menu option “Save $50” could push the task to the child of saving $50, and once the child saves $50, the parent could reward the child with paying the child a predetermined amount, and the parent's application could automatically transfer this amount to the child's bank account. Finally, the “Match 50 amounts” task could be a series of tasks or challenges where the child has to count out 50 different amounts to obtain a reward.

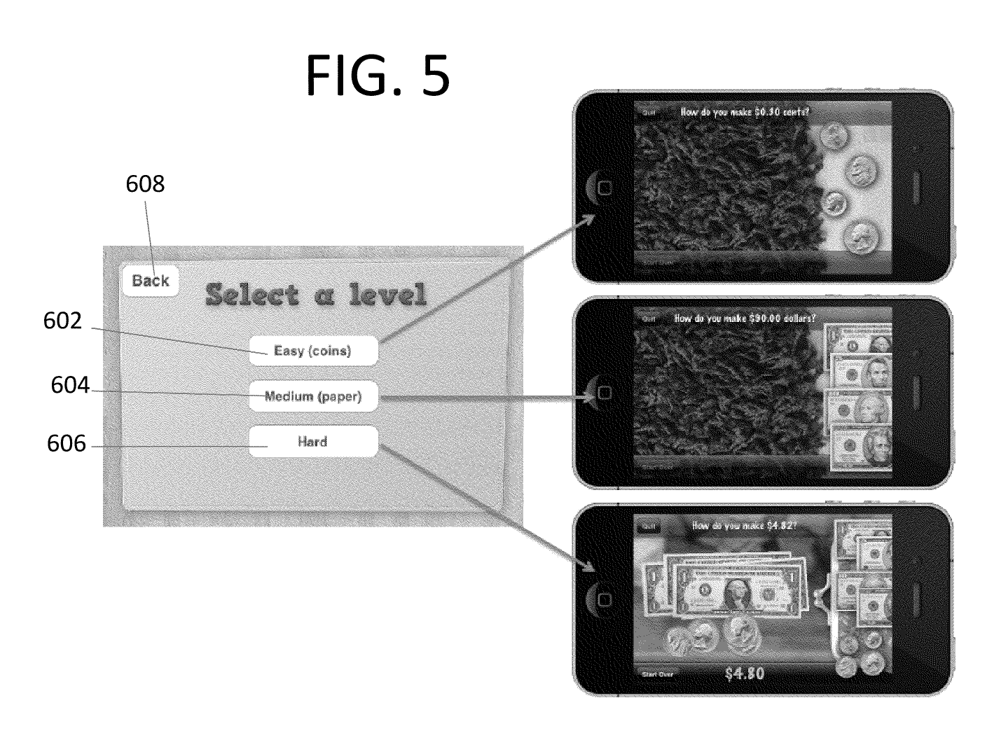

FIG. 5 shows the next menu screen after the user selects “Money Counting” 404 in the screen display in FIG. 3. In this exemplary embodiment, the user is provided with four selection options, “Easy (coins)” 602, “Medium (paper)” 604, “Hard” 606 and “Back” 608. FIG. 5 also shows respective screen shots of a smart phone display for each of “Easy (coins)” 602, “Medium (paper)” 604, “Hard” 606. The “Easy (coins)” game can give the user a relatively easier task of selecting and counting coins to form an amount such as $0.50. The “Medium (paper)” game can be the next level which the user is tasked with counting out paper currency to form an amount such as $30.00. Finally the “Hard” money counting game can task the user with counting both paper and coin currency to form an amount such as $4.82.

A common application can be downloaded by each of the user devices, and the devices can be linked through the common application in such a way that tasks can be pushed from one user to another. Alternatively, different applications can be configured to communicate with each other. For example, a parent can push tasks from an online banking application to a child's money counting application. The user can link to various other users by use of phone number, serial number of the device, passwords, email addresses, or using any other known methods.

Once the devices are linked to each other, the user can customize a hierarchy with the particular users' devices. For example, a parent can customize the settings to identify the users according to relationship, (e.g. husband, wife, daughter, son, and the like) and identify the ages of the users. In this way, the application can suggest certain tasks that might be appropriate for each of the users, and the application may also suggest certain rewards that may be appropriate for each of the users. However, it is also contemplated that the tasks and rewards can be customized by the users.

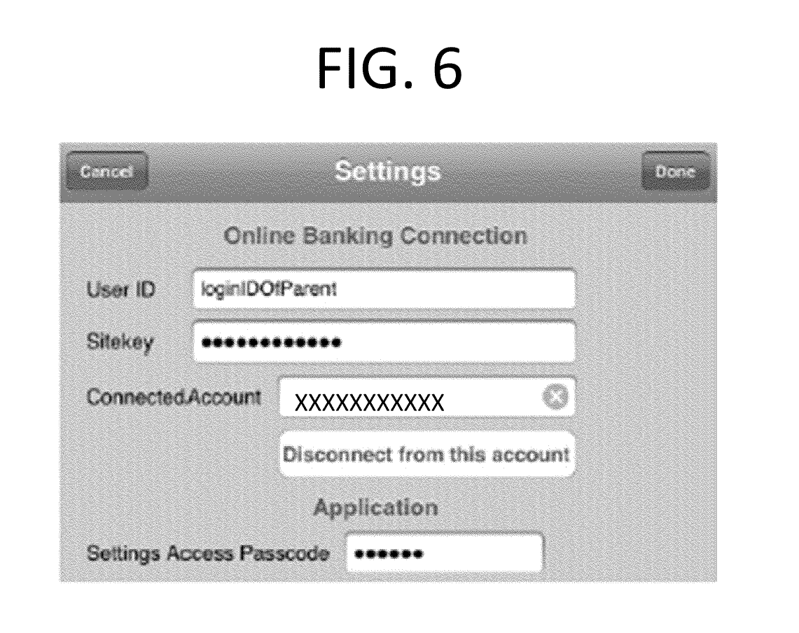

FIG. 6 shows a settings screen shot, which can link the user's application to a bank account. The user can then enter their User ID, Sitekey or password, Connected Account information, and Settings Access Passcode to configure the application for use.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method comprising:
transmitting by a first device having a first processor a task request initiated by a first user from the first device to a second device, wherein the task is configured to be received by the second device so that a second user can perform the task;
receiving by the first device a notice that the second user has performed the task; and
transmitting by the first device a request for a financial transaction from an account held by the first user to an account held by the second user to reward the second user for performing the task.

2. The computer implemented method of claim 1 wherein the task relates to finances.

3. The computer implemented method of claim 2 wherein the task comprises counting currency.

4. The computer implemented method of claim 1 wherein the transaction comprises a monetary amount delivered to an account held by the second user.

5. The computer implemented method of claim 4 wherein the account held by the second user is linked to the second device such that the monetary amount is transferred into the account held by the second user.

6. The computer implemented method of claim 1 wherein the transaction comprises purchasing a credit to a vendor.

7. The computer implemented method of claim 1 further configuring the first device to automatically reward the second user after a predetermined one or more tasks are performed by the second user on the second device.

8. The computer implemented method of claim 1 further comprising transmitting a second task by the first device to a third device and receiving by the first device a notice that a third user has performed the second task on the third device.

9. The computer implemented method of claim 1 further comprising setting an option for the first user on the first device to customize a reward for the second user.

10. The computer implemented method of claim 1 further comprising transmitting by the first device a notice of a reward to the second device in response to the second user performing the task on the second device.

11. A computer implemented method comprising:
receiving a task request from a first device initiated by a first user on a second device having a processor;
displaying the task on the second device and providing a second user an option to perform the task on the second device;
sending a message from the second device to the first device that the task has been performed by the second user and alerting the first user that the task has been performed;
receiving and displaying a notice of a monetary reward amount on the second device in response to the second user performing the task on the second device; and
withdrawing the monetary award amount from an account held by the first user and transferring the monetary award amount to the account held by the second user.

12. The computer implemented method of claim 11 wherein the task relates to finances.

13. The computer implemented method of claim 12 wherein the task comprises counting currency and the second device provides a graphical user interface for the second user to virtually count currency.

14. The computer implemented method of claim 11 wherein the reward is a monetary amount.

15. The computer implemented method of claim 14 wherein an account held by the second user is linked to the second device such that the monetary amount is transferred into the account held by the second user from an account held by the first user.

16. The computer implemented method of claim 11 wherein the reward is a credit to a vendor.

17. The computer implemented method of claim 11 wherein the second user is automatically rewarded after a predetermined one or more tasks are performed by the second user on the second device.

18. The computer implemented method of claim 11 wherein the second device is configured to lock up at least partially when the second user does not perform the task after a predetermined amount of time.

19. A computer program product, comprising a computer usable medium having a non-transitory computer readable program code embodied therein, said computer readable program code adapted to be executed by a processor to implement a method comprising:
receiving a task request by a first device initiated by a first user on a second device;
displaying the task on the second device and providing a second user an option to perform the task on the second device;
communicating by the second device to the first device that the task has been performed by the second user and alerting the first user that the task has been performed;
receiving a reward notice of a monetary award amount on the second device transmitted by the first device; and
withdrawing the monetary award amount from an account held by the first user and transferring the monetary award amount to the account held by the second user.

20. The computer program product of claim 19 wherein the second device is linked to the second user's bank account and wherein the second user is rewarded by receiving a monetary amount in the second user's bank account.

21. The computer program product of claim 19 wherein the task comprises counting currency and the second device provides a graphical user interface for the second user to virtually count currency.

22. The computer implemented method of claim 1 wherein the task is selected based on ability or age of the second user.

23. The computer implemented method of claim 1 wherein the second user's device is configured to provide reminders to the second user to complete the task.

24. The computer implemented method of claim 1 wherein the first user's device is configured to provide reminders to the first user to follow up with the second user to complete the task.

25. The computer implemented method of claim 1 further comprising providing default settings for the reward based on the difficulty and number of tasks.
